(19) United States
(12) Patent Application Publication
(10) Pub. No.: US 2012/0159202 A1
(43) Pub. Date: Jun. 21, 2012

(54) POWER SUPPLY APPARATUS SUITABLE FOR COMPUTER

(75) Inventors: Ming Xu, Nanjing (CN); Zhang-He Nan, Nanjing (CN); Ju-Lu Sun, Nanjing (CN); Wen-Chang Han, Nanjing (CN)

(73) Assignees: FSP-POWERLAND TECHNOLOGY INC., Nanjing (CN); FSP TECHNOLOGY INC., Taoyuan County (TW)

(21) Appl. No.: 13/325,068

(22) Filed: Dec. 14, 2011

(30) Foreign Application Priority Data
Dec. 20, 2010 (CN) 201010595991.4

(51) Int. Cl. G06F 1/26

(52) U.S. Cl. 713/300

(57) ABSTRACT

A power supply apparatus suitable for a computer is provided. The provided power supply apparatus includes an isolated DC-DC converter, an auxiliary power conversion circuit and a switching circuit. The isolated DC-DC converter receives and converts an input voltage, so as to generate a first main power. The auxiliary power conversion circuit receives and converts the input voltage, so as to generate an auxiliary power. The switching circuit receives the first main power and the auxiliary power, wherein the switching circuit outputs the received auxiliary power to be served as a standby power of the power supply apparatus when the power supply apparatus is in a standby state; moreover, the switching circuit outputs the received first main power to be served as the standby power of the power supply apparatus when the power supply apparatus is in an operation state.

### CROSS-REFERENCE TO RELATED APPLICATION

This application claims the priority benefit of China application serial no. 201010595991.4, filed on Dec. 20, 2010. The entirety of the above-mentioned patent application is hereby incorporated by reference herein and made a part of this specification.

### BACKGROUND OF THE INVENTION

1. Field of the Invention

The invention relates to a power supply technology, more particularly, to a power supply apparatus suitable for a computer.

2. Description of Related Art

A multi-output switching power supply used in a personal computer (PC) or a server generally requires a standby power to the power supply itself and a control circuit of the system. According to a current specification of the power supply, the standby power is 5V, and a maximum current thereof is about 4A. Since the flyback power conversion circuit is simple in structure and control, a commonly used solution is to use the flyback power conversion circuit to convert a rectified direct current (DC) bus voltage (for example, 400V of high voltage) into the required 5V standby power (5VSB).

In a TOPSwitch, a high voltage metal-oxide-semiconductor field-effect transistor (MOSFET), a pulse width modulation (PWM) controller, a fault protection circuit and other control circuits are integrated to a single complementary metal-oxide-semiconductor (CMOS) chip, and only a few external components are used in collocation with the TOPSwitch to form the flyback power conversion circuit. Therefore, the TOPSwitch becomes a first choice in the switching power supply pursuing a high power density (specifically recited in [1], i.e. http://www.powerint.com).

FIG. 1 is a diagram illustrating a standby power (5VSB) with a 5V output implemented by the TOPSwitch U1. A resistor R1, a capacitor C1 and a diode D1 form an absorption circuit to absorb leakage inductance energy relating to the transformer T1, so as to avoid the high voltage MOSFET to endure a large voltage peak, wherein the rectifier diode D2 can be implemented by a Schottky diode. The Schottky diode has a small forward voltage drop, which avails reducing a conduction loss, and a reverse recovery time thereof is very short, so that a reverse recovery loss can be greatly reduced.

It is known that due to characteristics of a high-voltage stress, a lossy absorber used for absorbing the leakage energy, and particularly a hard switching characteristic, the flyback power conversion circuit has a low efficiency, and a typical value thereof is not greater than 80%, which becomes a bottleneck for improving a light load efficiency of the multi-output switching power supply. Therefore, some types of high-efficiency flyback power conversion circuits with improved performance are disclosed, and in one type, output diodes are replaced by synchronous rectifiers (SRs), which avail improving a heavy load efficiency, though it is of no avail of improving the light load efficiency, and due to usage of the synchronous rectifiers and a driving integrated circuit (IC) of the synchronous rectifiers, cost thereof is greatly increased. Another type is a quasi-resonant soft-switching flyback power conversion circuit, in which an output capacitance of the switch MOSFET and a primary side inductance of a transformer are used to produce resonance, and valley voltage conduction is implemented through a suitable control, by which a switching loss is reduced, and efficiency of an entire load range is improved. Although such circuit can achieve efficiency improvement, compared to the TOPSwitch, an independent IC and independent high-voltage MOSFET are required, and a complicated external control circuit and protection circuit are also required.

### SUMMARY OF THE INVENTION

The invention is directed to a power supply apparatus suitable for a computer, so as to improve computer power supply efficiency.

An exemplary embodiment of the invention provides a power supply apparatus suitable for a computer, and the provided power supply apparatus includes an isolated DC-DC converter, an auxiliary power conversion circuit and a switching circuit. The isolated DC-DC converter is used for receiving and converting an input voltage, so as to generate a first main power. The auxiliary power conversion circuit is used for receiving and converting the input voltage, so as to generate an auxiliary power. The switching circuit is coupled to the isolated DC-DC converter and the auxiliary power conversion circuit. The switching circuit is used for outputting the auxiliary power to be served as a standby power of the power supply apparatus when the power supply apparatus is in a standby state. Moreover, the switching circuit is used for outputting the first main power to be served as the standby power of the power supply apparatus when the power supply apparatus is in an operation state.

In an exemplary embodiment of the invention, the switching circuit includes a first diode and a second diode. An anode of the first diode is used for receiving the first main power. Anode of the second diode is used for receiving the auxiliary power. Cathodes of the first and the second diodes are coupled to each other for outputting the first main power or the auxiliary power.

In an exemplary embodiment of the invention, the isolated DC-DC converter is inactivated when the power supply apparatus is in the standby state, such that the first main power is 0V (volt), and the second diode conducts the auxiliary power to be served as the standby power of the power supply apparatus.

In an exemplary embodiment of the invention, the first main power is greater than the auxiliary power, and the isolated DC-DC converter is activated when the power supply apparatus is in the operation state, such that the first diode conducts the first main power to be served as the standby power of the power supply apparatus.

In another exemplary embodiment of the invention, the switching circuit includes a first power switch and a second power switch. A first terminal of the first power switch is used for receiving the first main power, and a control terminal of the first switch is used for receiving a first control signal. A first terminal of the second power switch is used for receiving the auxiliary power, and a control terminal of the second switch is used for receiving a second control signal. Second terminals of the first and the second power switches are coupled to each other for outputting the first main power or the auxiliary power.

In an exemplary embodiment of the invention, when the power supply apparatus is in the standby state, the first power switch is turned off in response to the first control signal, and the second power switch is turned on in response to the second control signal. In addition, when the power supply apparatus is in the operation state, the first power switch is turned on in response to the first control signal, and the second power switch is turned off in response to the second control signal.

In an exemplary embodiment of the invention, the isolated DC-DC converter is inactivated when the power supply apparatus is in the standby state, such that the first main power is 0V (volt), and the second power switch conducts the auxiliary power to be served as the standby power of the power supply apparatus. In addition, the isolated DC-DC converter is activated when the power supply apparatus is in the operation state, such that the first power switch conducts the first main power to be served as the standby power of the power supply apparatus.

In an exemplary embodiment of the invention, the isolated DC-DC converter is further used for converting the input voltage, so as to generate a second main power and a third main power. In this case, the isolated DC-DC converter may be an isolated multi-output DC-DC converter.

In an exemplary embodiment of the invention, the provided power supply apparatus may be a switching power supply apparatus.

In an exemplary embodiment of the invention, the auxiliary power conversion circuit may be a flyback power conversion circuit.

In an exemplary embodiment of the invention, the provided power supply apparatus may further include a rectification circuit. The rectification circuit is used for receiving and converting an AC voltage, so as to generate the input voltage.

In an exemplary embodiment of the invention, the provided power supply apparatus may further include a power factor correction converter. The power factor correction converter is coupled to the rectification circuit, and used for performing a power factor correction on the input voltage.

In an exemplary embodiment of the invention, the provided power supply apparatus may further include an electromagnetic interference filter. The electromagnetic interference filter is coupled between the AC voltage and the rectification circuit, and used for suppressing electromagnetic noise of the AC voltage.

According to the above descriptions, due to the switching circuit is equipped in the power supply apparatus, not only the efficiency of the power supply apparatus is improved, but also a complicated external control circuit and extra components are not required. The generation of high-efficiency standby power is implemented with a minimum cost, and is adapted to a multi-output switching power supply, for example, a

PC power supply or a server power supply, etc.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a standby power (5VSB) with a 5V output implemented by the TOP Switch U1.

FIG. 2 is a diagram of a power supply apparatus 20 suitable for a computer according to an exemplary embodiment of the invention.

FIG. 3 is an implementation diagram of a switching circuit 205 according to an embodiment of the invention.

FIG. 4 is an implementation diagram of a switching circuit 205 according to another embodiment of the invention.

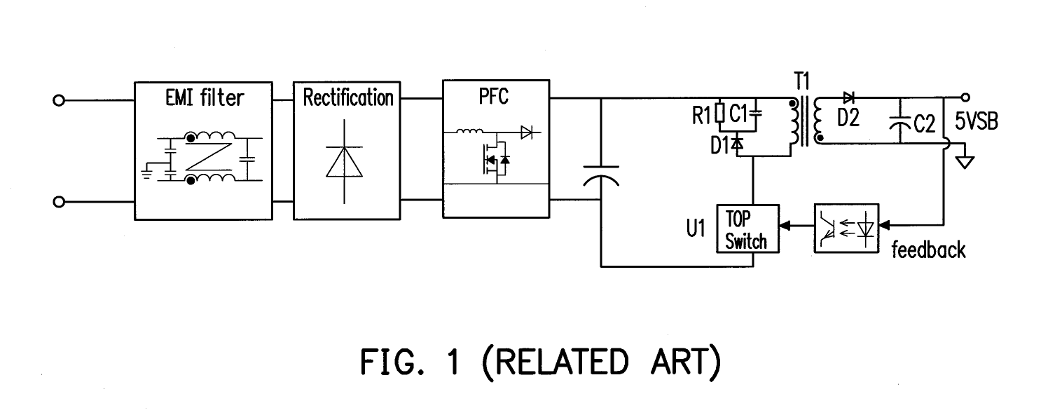

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

It should be firstly noted that, in the invention, when a power supply normally operates, a main output in a multi-output circuit is used to replace an output of a conventional flyback circuit to be served as the standby power. The main output of the multi-output power supply has higher efficiency, a current platinum PC power 5V output has efficiency of 96%, and the efficiency of the conventional flayback circuit is lower than 80%.

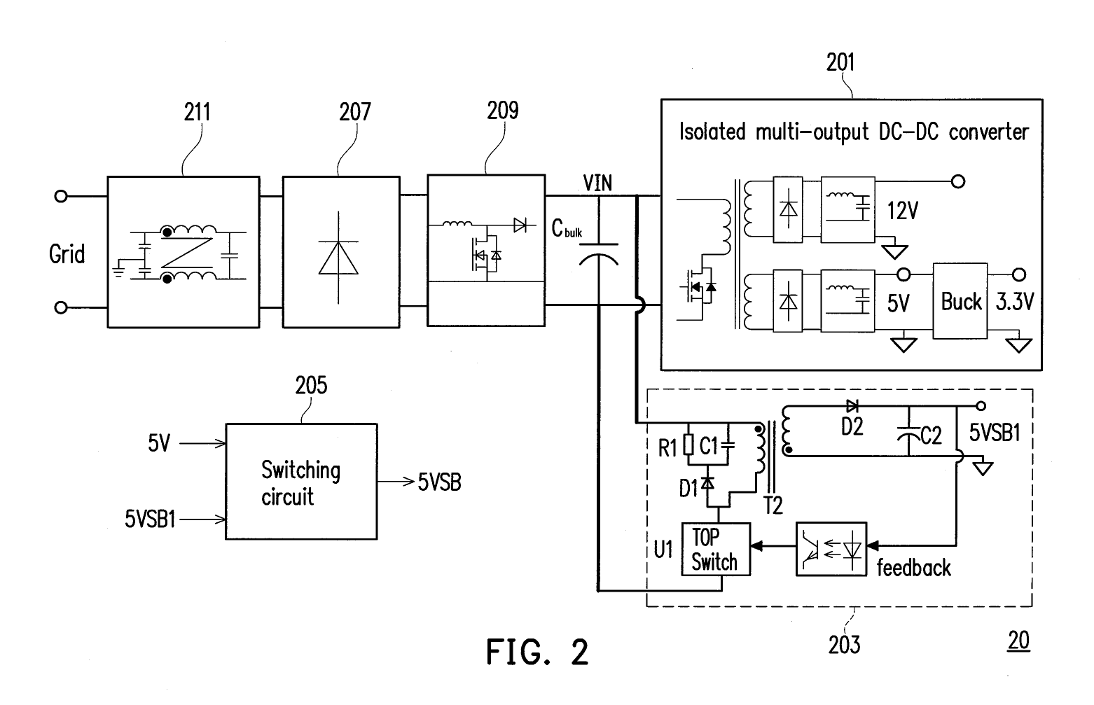

Accordingly, FIG. 2 is a diagram of a power supply apparatus 20 suitable for a computer according to an exemplary embodiment of the invention. Referring to FIG. 2, the power supply apparatus 20 may be a switching power supply apparatus, but not limited thereto. The power supply apparatus 20 includes an isolated (multi-output) DC-DC converter 201, an auxiliary power conversion circuit 203, a switching circuit 205, a rectification circuit 207, a power factor correction (PFC) converter 209, an electromagnetic interference (EMI) filter 211, and a bulk capacitor Cbulk.

In this exemplary embodiment, the isolated multi-output DC-DC converter 201 is used for receiving an input voltage VIN (for example, 400V of DC voltage, but not limited thereto), and converting (i.e. DC-DC conversion) the received input voltage VIN, so as to generate a first main power 5V, a second main power 12V and a third main power 3.3V. The input voltage VIN is generated after an AC voltage (or called “grid voltage”) Grid is processed through the EMI filter 211, the rectification circuit 207 and the PFC converter 209.

To be specific, the rectification circuit 207 is used for receiving the AC voltage Grid, and rectifying the received AC voltage Grid, so as to generate the input voltage VIN. The PFC converter 209 is coupled to the rectification circuit 207, and used for performing a power factor correction on the input voltage VIN from the rectification circuit 207, so as to generate 400V of input voltage VIN on the bulk capacitor Cbulk. The EMI filter 211 is coupled between the AC voltage Grid and the rectification circuit 207, and used for suppressing electromagnetic noise of the AC voltage Grid.

In addition, the auxiliary power conversion circuit 203 may be a TOPSwitch flyback power conversion circuit. In this exemplary embodiment, the auxiliary power conversion circuit 203 is used for receiving the input voltage VIN, and converting (i.e. DC-DC conversion) the received input voltage VIN, so as to generate an auxiliary power 5VSB1. To be specific, as shown in FIG. 2, the resistor R1, the capacitor C1 and the diode D1 form an absorption circuit to absorb leakage inductance energy relating to the transformer T2, so as to avoid the high voltage MOSFET in the TOPSwitch control chip U1 to endure a large voltage peak. The auxiliary power 5VSB1 is generated by the rectification of the diode D2 implemented by a Schottky diode and the filtering of the capacitor C2. The TOPSwitch control chip U1 can adjust the auxiliary power 5VSB1 in response to a feedback relating to the auxiliary power 5VSB1 and from the photocoupler.

Furthermore, the switching circuit 205 is coupled to the isolated multi-output DC-DC converter 201 and the auxiliary power conversion circuit 203. The switching circuit 205 is used for receiving the first main power 5V from the isolated multi-output DC-DC converter 201 and the auxiliary power 5VSB1 from the auxiliary power conversion circuit 203. In this exemplary embodiment, when the power supply apparatus 20 is in a standby state, the switching circuit 205 would output the auxiliary power 5VSB1 to be served as a standby power 5VSB. Moreover, when the power supply apparatus 20 is in an operation state, the switching circuit 205 would output the first main power 5V to be served as the standby power 5VSB.

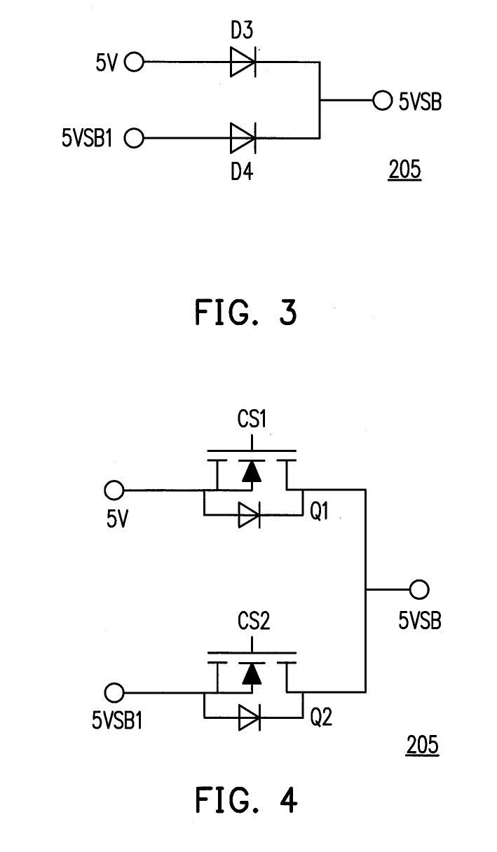

To be specific, FIG. 3 is an implementation diagram of the switching circuit 205 according to an embodiment of the invention. Referring to FIGS. 2 and 3, the switching circuit 205 as shown in FIG. 3 may include diodes D3 and D4. An anode of the diode D3 is used for receiving the first main power 5V from the isolated multi-output DC-DC converter 201. An anode of the diode D4 is used for receiving the auxiliary power 5VSB1 from the auxiliary power conversion circuit 203. Cathodes of the diodes D3 and D4 are coupled to each other for outputting the first main power 5V or the auxiliary power 5VSB1.

In this exemplary embodiment, the isolated multi-output DC-DC converter 201 is inactivated when the power supply apparatus 20 is in the standby state, such that the first main power 5V is not generated (i.e. 0-volt). In this case, the diode D4 would conduct the auxiliary power 5VSB1 generated by the auxiliary power conversion circuit 203 to be served as the standby power 5VSB of the power supply apparatus 20. At this time, 5VSB=5VSB1−VD4, where the VD4 is the forward bias of the diode D4.

On the other hand, according to a specification of the power supply, the output of the power supply is allow to have a certain error/tolerance, taking the standby power 5VSB as an example, the allowable error/tolerance is ±5%, i.e. a maximum voltage is 5.25V and a minimum voltage is 4.75V. Accordingly, under a suitable design, in this exemplary embodiment, the first main power 5V generated by the isolated multi-output DC-DC converter 201 can be designed and inclined to the upper limit 5.25V, and the auxiliary power 5VSB1 generated by the auxiliary power conversion circuit 203 and conducted after the diode D4 can be designed and inclined to the lower limit 4.75V, so that the power of the standby power 5VSB is entirely or mostly provided by the first main power 5V generated by the isolated multi-output DC-DC converter 201 when the power supply apparatus 20 is in the operation state.

Accordingly, under a condition of that the first main power 5V is greater than the auxiliary power 5VSB1, the isolated multi-output DC-DC converter 201 is activated when the power supply apparatus 20 is in the operation state, such that the first main power 5V is generated (i.e. the maximum of 5.25V). In this case, the diode D3 would conduct the first main power 5V generated by the isolated multi-output DC-DC converter 201 to be served as the standby power 5VSB of the power supply apparatus 20. At this time, 5VSB=5.25V−VD3, where the VD3 is the forward bias of the diode D3.

It should be noted that, under the condition of that the first main power 5V is greater than the auxiliary power 5VSB1, the auxiliary power conversion circuit 203 formed by the TOPSwitch (i.e. the flyback power conversion circuit) is operated at a no-load mode, and TOPSwitch-JX series may have a no-load loss of 70 mW in case of a 230 VAC input. Due to the relatively high efficiency of the isolated multi-output DC-DC converter 201, the novel scheme provided by the invention can greatly reduce a loss of the auxiliary power conversion circuit 203 (i.e. the flyback power conversion circuit), so as to improve the efficiency of the whole power supply apparatus 20.

Besides, FIG. 4 is an implementation diagram of a switching circuit 205 according to another embodiment of the invention. Referring to FIGS. 2 and 4, the switching circuit 205 as shown in FIG. 4 may include power switches Q1 and Q2. A first terminal of the power switch Q1 is used for receiving the first main power 5V from the isolated multi-output DC-DC converter 201, and a control terminal of the power switch Q1 is used for receiving a control signal CS1. A first terminal of the power switch Q2 is used for receiving the auxiliary power 5VSB1 from the auxiliary power conversion circuit 203, and a control terminal of the power switch Q2 is used for receiving a control signal CS2. Second terminals of the power switches Q1 and Q2 are coupled to each other for outputting the first main power 5V or the auxiliary power 5VSB1.

In this exemplary embodiment, when the power supply apparatus 20 is in the standby state, the power switch Q1 is turned off in response to the control signal CS1, and the power switch Q2 is turned on in response to the control signal CS2. In addition, when the power supply apparatus 20 is in the operation state, the power switch Q1 is turned on in response to the control signal CS1, and the power switch Q2 is turned off in response to the control signal CS2.

Accordingly, the isolated multi-output DC-DC converter 201 is inactivated when the power supply apparatus 20 is in the standby state, such that the first main power 5V is not generated (i.e. 0-volt). In this case, the power switches Q1 and Q2 would respectively turned off and turned on in response to the control signals CS1 and CS2, such that the power switch Q2 would conduct the auxiliary power 5VSB1 generated by the auxiliary power conversion circuit 203 to be served as the standby power 5VSB of the power supply apparatus 20.

On the other hand, the isolated multi-output DC-DC converter 201 is activated when the power supply apparatus 20 is in the operation state, such that the first main power 5V is generated. In this case, the power switches Q1 and Q2 would respectively turned on and turned off in response to the control signals CS1 and CS2, such that the power switch Q1 would conduct the first main power 5V generated by the isolated multi-output DC-DC converter 201 to be served as the standby power 5VSB of the power supply apparatus 20.

Similarly, due to the power switch Q2 is turned off when the power supply apparatus 20 is in the operation state, the auxiliary power conversion circuit 203 formed by the TOPSwitch (i.e. the flyback power conversion circuit) is operated at a no-load mode, and TOPSwitch-JX series may have a no-load loss of 70 mW in case of a 230VAC input. Due to the relatively high efficiency of the isolated multi-output DC-DC converter 201, the novel scheme provided by the invention can greatly reduce a loss of the auxiliary power conversion circuit 203 (i.e. the flyback power conversion circuit), so as to improve the efficiency of the whole power supply apparatus 20.

In summary, due to the switching circuit 205 is equipped in the power supply apparatus 20, not only the efficiency of the power supply apparatus 20 is improved (because the main output in a multi-output circuit has higher efficiency, and the efficiency of the conventional flayback circuit has relatively lower efficiency), but also a complicated external control circuit and extra components are not required. The generation of high-efficiency standby power 5VSB is implemented with a minimum cost, and is adapted to a multi-output switching power supply, for example, a PC power supply or a server power supply, etc, but not limited thereto.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power supply apparatus, suitable for a computer, the power supply apparatus comprising:
an isolated DC-DC converter, configured for receiving and converting an input voltage, so as to generate a first main power;
an auxiliary power conversion circuit, configured for receiving and converting the input voltage, so as to generate an auxiliary power; and
a switching circuit, coupled to the isolated DC-DC converter and the auxiliary power conversion circuit, configured for receiving the first main power and the auxiliary power, outputting the auxiliary power to be served as a standby power of the power supply apparatus when the power supply apparatus is in a standby state, and outputting the first main power to be served as the standby power of the power supply apparatus when the power supply apparatus is in an operation state.

2. The power supply apparatus according to claim 1, wherein the switching circuit comprising:
a first diode, having an anode receiving the first main power; and
a second diode, having an anode receiving the auxiliary power,
wherein cathodes of the first and the second diodes are coupled to each other for outputting the first main power or the auxiliary power.

3. The power supply apparatus according to claim 2, wherein the isolated DC-DC converter is inactivated when the power supply apparatus is in the standby state, such that the first main power is 0 volt, and the second diode conducts the auxiliary power to be served as the standby power of the power supply apparatus.

4. The power supply apparatus according to claim 2, wherein the first main power is greater than the auxiliary, and the isolated DC-DC converter is activated when the power supply apparatus is in the operation state, such that the first diode conducts the first main power to be served as the standby power of the power supply apparatus.

5. The power supply apparatus according to claim 1, wherein the switching circuit comprising:
a first power switch, having a first terminal receiving the first main power and a control terminal receiving a first control signal; and
a second power switch, having a first terminal receiving the auxiliary power and a control terminal receiving a second control signal,
wherein second terminals of the first and the second power switches are coupled to each other for outputting the first main power or the auxiliary power.

6. The power supply apparatus according to claim 5, wherein when the power supply apparatus is in the standby state, the first power switch is turned off in response to the first control signal, and the second power switch is turned on in response to the second control signal.

7. The power supply apparatus according to claim 6, wherein when the power supply apparatus is in the operation state, the first power switch is turned on in response to the first control signal, and the second power switch is turned off in response to the second control signal.

8. The power supply apparatus according to claim 7, wherein the isolated DC-DC converter is inactivated when the power supply apparatus is in the standby state, such that the first main power is 0 volt, and the second power switch conducts the auxiliary power to be served as the standby power of the power supply apparatus.

9. The power supply apparatus according to claim 7, wherein the isolated DC-DC converter is activated when the power supply apparatus is in the operation state, such that the first power switch conducts the first main power to be served as the standby power of the power supply apparatus.

10. The power supply apparatus according to claim 1, wherein the isolated DC-DC converter is further configured for converting the input voltage, so as to generate a second main power and a third main power.

11. The power supply apparatus according to claim 10, wherein the isolated DC-DC converter is an isolated multi-output DC-DC converter.

12. The power supply apparatus according to claim 10, wherein the power supply apparatus is a switching power supply apparatus.

13. The power supply apparatus according to claim 1, wherein the auxiliary power conversion circuit is a flyback power conversion circuit.

14. The power supply apparatus according to claim 1, further comprising:
a rectification circuit, configured for receiving and converting an AC voltage, so as to generate the input voltage.

15. The power supply apparatus according to claim 14, further comprising:
a power factor correction converter, coupled to the rectification circuit, configured for performing a power factor correction on the input voltage.

16. The power supply apparatus according to claim 15, further comprising:
an electromagnetic interference filter, coupled between the AC voltage and the rectification circuit, configured for suppressing electromagnetic noise of the AC voltage.
